(19) United States
(12) Patent Application Publication
(10) Pub. No.: US 2026/0202816 A1
(43) Pub. Date: Jul. 16, 2026

(54) IMPLEMENTING AUTOMATION TESTING IN A MULTISYSTEM

(71) Applicant: International Business Machines Corporation, Armonk, NY (US)

(72) Inventors: Yu Long Zhang, Beijing (CN); XiaoWan Lu, Beijing (CN); Mai Zeng, Beijing (CN); Peng Hui Jiang, Beijing (CN)

(21) Appl. No.: 19/020,989

(22) Filed: Jan. 14, 2025

(51) Int. Cl. G05B 19/406

(52) U.S. Cl. CPC G05B 19/406; G05B 2219/31316

(57) ABSTRACT

A computer-implemented method, system, and computer program product for implementing an automation test in a multisystem. A matrix of information for each node in the multisystem is generated based on analyzing the log information for each node. The matrix includes error information, such as an error type, an error reason, an error time, and an error position. Error information for an error in the matrix for a node in the multisystem is then quantified and a corresponding action to handle the error is then returned. The action for handling the error for the node is then implemented followed by scheduling the node for participating in the automation test. In this manner, automation testing may be effectively implemented in a multisystem, including in situations involving the occurrence of an error.

### TECHNICAL FIELD

The present disclosure relates generally to multisystems, and more particularly to effectively implementing automation testing in a multisystem by handling errors of nodes of the multisystem prior to performing the automation test.

### BACKGROUND

As the number of users on a computing system increases, a single subsystem for a set of work is often insufficient. As a result, computing systems, referred to as multisystems, are divided into multiple subsystems. By implementing a multisystem, there is an improved manageability of work. For example, there is better control over what work is running in each subsystem. For instance, the database server jobs are isolated to one subsystem, the remote command server jobs are isolated to a different subsystem, the distributed data management server jobs are isolated to another different subsystem and so on. Additionally, by using multiple subsystems, groups of jobs can be isolated with their own memory pools. In this manner, one group does not adversely impact other jobs.

As discussed above, multisystems are divided into multiple subsystems. These subsystems collaborate with each other to fulfill computation tasks, showcasing distinctive features, such as large physical distribution (scenario where a large amount of data or computing power is spread across a wide network of geographically dispersed physical servers), large concurrent access (when multiple users or processes can access a system or component at the same time), timing sensitivity, and platform heterogeneity (differences in the underlying hardware, instruction set, and other platform characteristics of a computing system). Furthermore, operational methodologies vary across the different subsystems. For example, communication between subsystems may involve transmitting messages through different network protocols or different local interfaces.

Multisystems may be tested using automated testing (also known as “automation testing”). Automated testing is the application of software tools to automate a human-driven manual process of reviewing and validating a software product. Such automated testing may involve the testing of tasks of various components of a customer data platform of the multisystem. A customer data platform is a software application that unifies a company's customer data from multiple sources to create a single, comprehensive database. For example, in order to complete the testing of tasks of the various components of the customer data platform, it is necessary to compare whether the sent data and the received data are consistent.

When the received data and the sent data are consistent (i.e., passed verification), then it is concluded that there were no errors. However, when the received data and the sent data are not consistent, then it is said that verification was not passed (i.e., an error occurred). In such a scenario, the software system of the multisystem needs to be debugged to identify the source of the error. However, since the multisystem involves multiple subsystems, which may include different operating systems, the automation test may not succeed in diagnosing the error.

For example, it is difficult for the automation test to determine which subsystem or component caused the error. In another example, errors that occurred during the automation test may be complex. For instance, multiple errors may occur during the automation test, and such errors differ in many ways, such as network fluctuations, node downtime, etc. Furthermore, diagnosing errors that occur during the automation test may involve analyzing the log files. However, the log files of the components and nodes (e.g., processing nodes) of the multisystem are complex thereby making it difficult to quickly find useful information to be analyzed.

As a result, there is not currently a means for effectively implementing automation testing in a multisystem.

### SUMMARY

In one embodiment of the present disclosure, a computer-implemented method for implementing an automation test in a multisystem comprises generating a matrix of log information for each node in the multisystem based on analyzing the log information for each node. The method additionally comprises quantifying error information for an error in the matrix for a first node in the multisystem and returning a corresponding action to handle the error. Furthermore, the method comprises implementing the action for handling the error for the first node. Additionally, the method comprises scheduling the first node for participating in the automation test.

Additionally, in one embodiment of the present disclosure, the method further comprises vectoring the log information stored in the matrix for the first node in the multisystem into a first set of vectors, where the log information stored in the matrix comprises an error type. The method additionally comprises vectorizing a corpus of errors into a second set of vectors. Furthermore, the method comprises computing a distance between a first vector from the first set of vectors and a second vector from the second set of vectors. Additionally, the method comprises selecting the error and the action for handling the error stored in the corpus in response to the distance between the first vector from the first set of vectors with the second vector from the second set of vectors being less than a first threshold value.

Furthermore, in one embodiment of the present disclosure, the method additionally comprises generating a data structure for each node in the multisystem that comprises an identifier of the node, a status value representing a health status of the node, and the matrix. The method further comprises pre-running the automation test on nodes of the multisystem to calculate a value of the status value of the data structure for each of the nodes. Furthermore, the method comprises selecting a node with a highest value of the status value of the data structure that has processed an error. Additionally, the method comprises adding the selected node to a scheduling system for participating in the automation test.

Additionally, in one embodiment of the present disclosure, the value of the status value is calculated based on an amount of processing used by the node, an amount of memory used by the node, a percentage of disk space used by the node, a temperature of the node, and a network speed.

Furthermore, in one embodiment of the present disclosure, the method additionally comprises vectorizing log messages for the first node into a first set of vectors. The method further comprises vectorizing a corpus of errors into a second set of vectors. Additionally, the method comprises computing a distance between a first vector from the first set of vectors and a second vector from the second set of vectors. Furthermore, the method comprises storing an error type, an error reasons, an error time, and an error position in the matrix associated with a log message in response to the distance between the first vector from the first set of vectors and the second vector from the second set of vectors being less than a second threshold value.

Additionally, in one embodiment of the present disclosure, the method further comprises generating a data structure for each node in the multisystem that comprises an identifier of the node, a status value representing a health status of the node, and the matrix. The method additionally comprises updating a value of the status value of the data structure of the first node upon performing the automation test on the first node.

Furthermore, in one embodiment of the present disclosure, the method additionally comprises selecting a second action for handling a second error stored in a corpus of errors and actions handing the errors in response to the updated value of the status value not being less than a threshold value and the second error occurs.

Additionally, in one embodiment of the present disclosure, the method further comprises running the first node as a running node in response to the updated value of the status value being less than a threshold value.

Other forms of the embodiment of the computer-implemented method described above are in a system and in a computer program product.

Accordingly, embodiments of the present disclosure effectively implement automation testing in a multisystem, including in situations involving the occurrence of an error.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a computing environment for practicing the principles of the present disclosure;

FIG. 2 illustrates a multisystem in accordance with an embodiment of the present disclosure;

FIG. 3 illustrates the functionality of the log analysis module in accordance with an embodiment of the present disclosure;

FIG. 4 illustrates a data structure that is generated for each node by the status value calculation module in accordance with an embodiment of the present disclosure;

FIG. 5 illustrates calculating a value for the status value by the status value calculation module in accordance with an embodiment of the present disclosure;

FIG. 6 illustrates quantifying the error information in the second column of the matrix of log information and returning a corresponding action to handle such an identified error by the error response and processing module in accordance with an embodiment of the present disclosure;

FIG. 7 illustrates selecting a node to be added to the schedule for participating in the automation test by the decision-making module in accordance with an embodiment of the present disclosure;

FIGS. 8A-8B are a flowchart of a method for effectively implementing automation testing in a multisystem, including in situations involving the occurrence of an error, in accordance with an embodiment of the present disclosure;

FIG. 9 illustrates the sub-steps involved in generating a matrix of log information for each node in the multisystem based on analyzing the log information for each node in accordance with an embodiment of the present disclosure; and

FIG. 10 illustrates the sub-steps involved in quantifying the error information for an error in the second column of the matrix of log information and returning a corresponding action to handle such an identified error in accordance with an embodiment of the present disclosure.

### DETAILED DESCRIPTION

In one embodiment of the present disclosure, a computer-implemented method for implementing an automation test in a multisystem comprises generating a matrix of log information for each node in the multisystem based on analyzing the log information for each node. The method additionally comprises quantifying error information for an error in the matrix for a first node in the multisystem and returning a corresponding action to handle the error. Furthermore, the method comprises implementing the action for handling the error for the first node. Additionally, the method comprises scheduling the first node for participating in the automation test.

In this manner, automation testing is effectively implemented in a multisystem, including in situations involving the occurrence of an error.

Additionally, in one embodiment of the present disclosure, the method further comprises vectoring the log information stored in the matrix for the first node in the multisystem into a first set of vectors, where the log information stored in the matrix comprises an error type. The method additionally comprises vectorizing a corpus of errors into a second set of vectors. Furthermore, the method comprises computing a distance between a first vector from the first set of vectors and a second vector from the second set of vectors. Additionally, the method comprises selecting the error and the action for handling the error stored in the corpus in response to the distance between the first vector from the first set of vectors with the second vector from the second set of vectors being less than a first threshold value.

In this manner, error information for an error in a matrix for a node is quantified and a corresponding action to handle the error is returned.

Furthermore, in one embodiment of the present disclosure, the method additionally comprises generating a data structure for each node in the multisystem that comprises an identifier of the node, a status value representing a health status of the node, and the matrix. The method further comprises pre-running the automation test on nodes of the multisystem to calculate a value of the status value of the data structure for each of the nodes. Furthermore, the method comprises selecting a node with a highest value of the status value of the data structure that has processed an error. Additionally, the method comprises adding the selected node to a scheduling system for participating in the automation test.

In this manner, the node with the highest health status that has processed an error is added to the scheduling system for participating in the automation test.

Additionally, in one embodiment of the present disclosure, a value of the status value is calculated based on an amount of processing used by the node, an amount of memory used by the node, a percentage of disk space used by the node, a temperature of the node, and a network speed.

In this manner, the status value of a node accurately indicates the health status of the node.

Furthermore, in one embodiment of the present disclosure, the method additionally comprises vectorizing log messages for the first node into a first set of vectors. The method further comprises vectorizing a corpus of errors into a second set of vectors. Additionally, the method comprises computing a distance between a first vector from the first set of vectors and a second vector from the second set of vectors. Furthermore, the method comprises storing an error type, an error reasons, an error time, and an error position in the matrix associated with a log message in response to the distance between the first vector from the first set of vectors and the second vector from the second set of vectors being less than a second threshold value.

In this manner, a matrix of log information for a node is generated.

Additionally, in one embodiment of the present disclosure, the method further comprises generating a data structure for each node in the multisystem that comprises an identifier of the node, a status value representing a health status of the node, and the matrix. The method additionally comprises updating a value of the status value of the data structure of the first node upon performing the automation test on the first node.

In this manner, the status value for a node is updated to reflect the current health status of the node upon performing the automation test on the node.

Furthermore, in one embodiment of the present disclosure, the method additionally comprises selecting a second action for handling a second error stored in a corpus of errors and actions handing the errors in response to the updated value of the status value not being less than a threshold value and the second error occurs.

In this manner, the error that occurred during the node's participation in the automation test will be handled.

Additionally, in one embodiment of the present disclosure, the method further comprises running the first node as a running node in response to the updated value of the status value being less than a threshold value.

In this manner, the node functionally operates as normal in the multisystem.

Other forms of the embodiment of the computer-implemented method described above are in a system and in a computer program product.

As stated above, multisystems are divided into multiple subsystems. These subsystems collaborate with each other to fulfill computation tasks, showcasing distinctive features, such as large physical distribution (scenario where a large amount of data or computing power is spread across a wide network of geographically dispersed physical servers), large concurrent access (when multiple users or processes can access a system or component at the same time), timing sensitivity, and platform heterogeneity (differences in the underlying hardware, instruction set, and other platform characteristics of a computing system). Furthermore, operational methodologies vary across the different subsystems. For example, communication between subsystems may involve transmitting messages through different network protocols or different local interfaces.

Multisystems may be tested using automated testing (also known as “automation testing”). Automated testing is the application of software tools to automate a human-driven manual process of reviewing and validating a software product. Such automated testing may involve the testing of tasks of various components of a customer data platform of the multisystem. A customer data platform is a software application that unifies a company's customer data from multiple sources to create a single, comprehensive database. For example, in order to complete the testing of tasks of the various components of the customer data platform, it is necessary to compare whether the sent data and the received data are consistent.

When the received data and the sent data are consistent (i.e., passed verification), then it is concluded that there were no errors. However, when the received data and the sent data are not consistent, then it is said that verification was not passed (i.e., an error occurred). In such a scenario, the software system of the multisystem needs to be debugged to identify the source of the error. However, since the multisystem involves multiple subsystems, which may include different operating systems, the automation test may not succeed in diagnosing the error.

For example, it is difficult for the automation test to determine which subsystem or component caused the error. In another example, errors that occurred during the automation test may be complex. For instance, multiple errors may occur during the automation test, and such errors differ in many ways, such as network fluctuations, node downtime, etc. Furthermore, diagnosing errors that occur during the automation test may involve analyzing the log files. However, the log files of the components and nodes (e.g., processing nodes) of the multisystem are complex thereby making it difficult to quickly find useful information to be analyzed.

As a result, there is not currently a means for effectively implementing automation testing in a multisystem.

The embodiments of the present disclosure provide a means for effectively implementing automation testing in a multisystem. In one embodiment, log information for the nodes of the multisystem are analyzed in order to generate a matrix of log information. In one embodiment, such a matrix includes the error type, the error reason, the error time, and the error position. Furthermore, a data structure that includes an identifier of the node, a status value representing the health status of the node, and the matrix is generated for each node of the multisystem. In one embodiment, the value of the status value in the data structure is calculated based on the amount of processing used by the node, an amount of memory used by the node, a percentage of disk space used by the node, a temperature of the node, and a network speed. In one embodiment, the matrix of the data structure for a node in the multisystem is vectorized into a first set of vectors. Furthermore, a corpus of errors and actions handling such errors is vectorized into a second set of vectors. A distance between a vector from the first set of vectors and a vector from the second set of vectors is computed for each pair of vectors from the first and second sets of vectors. A pair of vectors from the first and second sets of vectors with a smallest distance is identified. If the distance between such a pair of vectors is less than a threshold value, then an error and an action for handing the error stored in the corpus associated with such a vector is selected. The selected action is then implemented for handling the error for the node. After implementing the action for handling the error for the node, the value of the status value in the data structure for the node is updated. Furthermore, in one embodiment, a module, referred to herein as the decision-making module, is configured to add a node to the scheduling system for performing the automation test. Such an added node may correspond to the node whose error was handled if the value of the status value is the highest among the values of the status values of the other nodes that have processed an error. In this manner, automation testing may be effectively implemented in a multisystem, including in situations involving the occurrence of an error. A further description of these and other features will be provided below.

In some embodiments of the present disclosure, the present disclosure comprises a computer-implemented method, system, and computer program product for implementing an automation test in a multisystem. In one embodiment of the present disclosure, a matrix of information for each node in the multisystem is generated based on analyzing the log information for each node. In one embodiment, the matrix includes error information, such as an error type, an error reason, an error time, and an error position. Error information for an error in the matrix for a node in the multisystem is then quantified and a corresponding action to handle the error is then returned. The action for handling the error for the node is then implemented followed by scheduling the node for participating in the automation test. In this manner, automation testing may be effectively implemented in a multisystem, including in situations involving the occurrence of an error.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

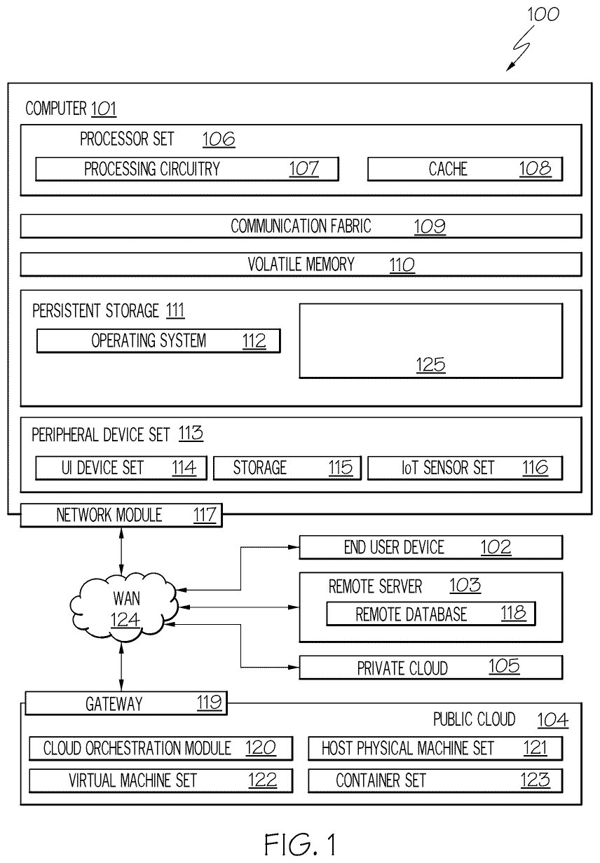

Referring now to the Figures in detail, FIG. 1 illustrates an embodiment of the present disclosure of a computing environment 100 for practicing the principles of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 125) involved in performing the inventive methods, such as effectively implementing automation testing in a multisystem, including in situations involving the occurrence of an error. In addition to block 125, computing environment 100 includes, for example, computer 101, network 124, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 125, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 125 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM.

Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 125 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 124. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 124 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 124 to EUD 102. In this way, EUD 102 can display, or otherwise present, the recommendation to an end user.

In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120.

The computing resources provided by public cloud 104 are typically implemented by virtual computing environments that run on various computers making up the computers of host physical machine set 121, which is the universe of physical computers in and/or available to public cloud 104. The virtual computing environments (VCEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 120 manages the transfer and storage of images, deploys new instantiations of VCEs and manages active instantiations of VCE deployments. Gateway 119 is the collection of computer software, hardware, and firmware that allows public cloud 104 to communicate through WAN 124.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 124 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

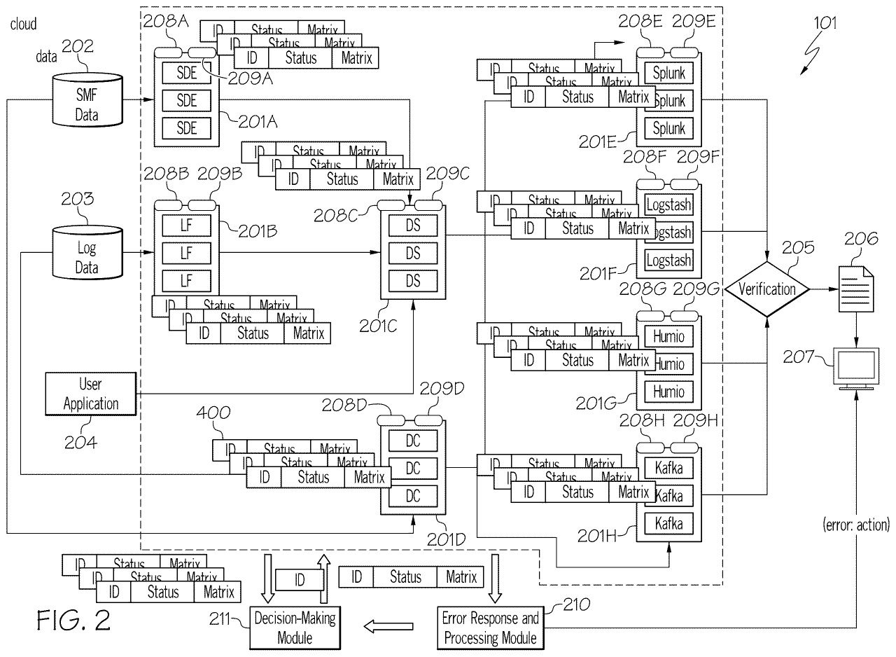

Block 125 further includes the software components discussed herein in connection with FIGS. 2-7 to effectively implement automation testing in a multisystem, including in situations involving the occurrence of an error. In one embodiment, such components may be implemented in hardware. The functions discussed above performed by such components are not generic computer functions. As a result, computer 101 is a particular machine that is the result of implementing specific, non-generic computer functions.

In one embodiment, the functionality of such software components of computer 101, including effectively implementing automation testing in a multisystem, including in situations involving the occurrence of an error, may be embodied in an application specific integrated circuit.

An embodiment of computer 101 (FIG. 1) implementing a multisystem is discussed below in connection with FIG. 2.

FIG. 2 illustrates a multisystem in accordance with an embodiment of the present disclosure.

Referring now to FIG. 2, computer 101 includes various subsystems, which includes components, such as nodes 201A-201H. Nodes 201A-201H may collectively or individually be referred to as nodes 201 or node 201, respectively. Each node 201 may correspond to a processing node, which may include a compute core, memory, and a secondary storage. Furthermore, in one embodiment, each node 201 may be configured to process various types of data, which may be obtained from the cloud, such as system management facility (SMF) data from database 202, log data from database 203, and requests from user applications 204. In one embodiment, SMF data records contain information about activities and events that occur on computer 101, including errors, software usage, network activity, system-level information, application information, security information and events, transaction information, database information, processor utilization, etc. In one embodiment, log data includes a record of events that occur within computer 101, such as system events, application events, user activity, performance metrics, security events, platform diagnostic information, etc.

In the embodiment involving a customer data platform, in order to complete the testing of tasks of the various components (e.g., nodes 201) of the customer data platform using an automation test, it is determined if the sent data and the received data are consistent. That is, in one embodiment, it is determined if the received data passes verification as shown by verification 205. A report 206 concerning the results of the automation test is generated and displayed on a monitor 207 of computer 101.

As previously discussed, the principles of the present disclosure effectively implement automation testing in a multisystem, including in situations involving the occurrence of an error. In one embodiment, computer 101 includes the software plug-in referred to herein as the “log analysis module” 208A-208H for each node 201A-201H, respectively. Log analysis modules 208A-208H may collectively or individually be referred to as log analysis modules 208 or log analysis module 208, respectively.

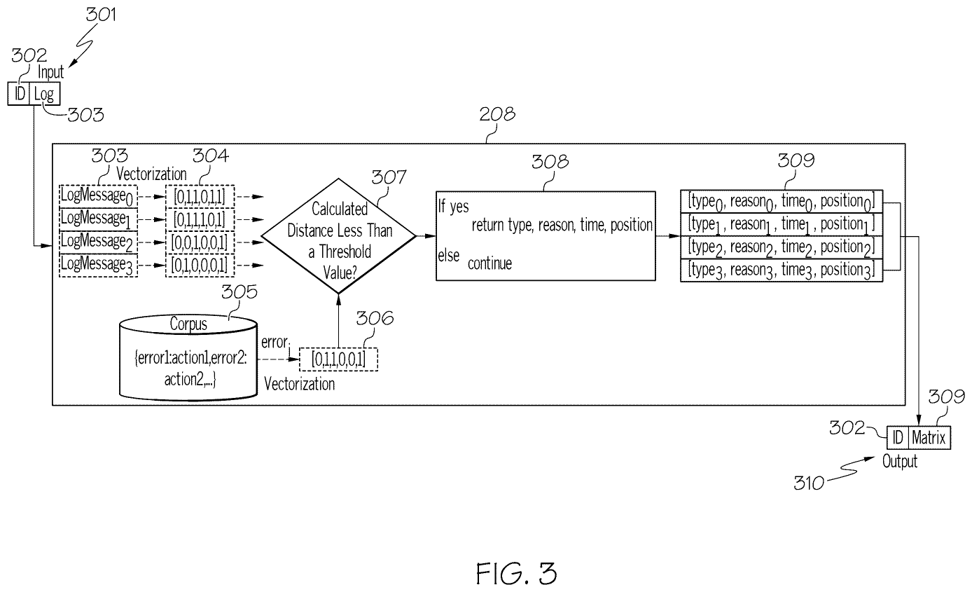

In one embodiment, log analysis module 208 is configured to generate a matrix of log information for each node 201 in the multisystem based on analyzing the log information for each node 201 as discussed below in connection with FIG. 3.

FIG. 3 illustrates the functionality of log analysis module 208 in accordance with an embodiment of the present disclosure.

Referring to FIG. 3, in conjunction with FIG. 2, log analysis module 208 (e.g., log analysis module 208A) is configured to receive log information 301, which includes an identifier 302 (“ID”) of the associated node 201 (e.g., node 201A) and the log message 303. Log message 303, as used herein, is record of an event that occurs in computer 101, such as an error, problem, or information about current operations. In one embodiment, log messages are created as part of the process of logging, which is the act of recording events in computer 101.

In one embodiment, log analysis module 208 vectorizes each log into a vector 304. That is, log analysis module 208 vectorizes log messages 303 into a set of vectors 304. Furthermore, in one embodiment, log analysis module 208 vectorizes a corpus of errors stored in database 305 (contains a corpus of errors and actions for handling such errors). That is, log analysis module 208 vectorizes the corpus of errors into a set of vectors 306. In one embodiment, such a database 305 is connected to computer 101 (FIG. 1), including via a network 124. In one embodiment, the corpus of errors and actions of database 305 is populated by an expert.

In one embodiment, log analysis module 208 computes the distance between a vector from each set of vectors 304, 306, such as computing the cosine distance. In one embodiment, the cosine distance between the vectors A, B is defined as:

$$cos ( A , B ) = \frac{{\sum }_{i = 1}^{n} {A}_{i} \times {B}_{i}}{\sqrt{{\sum }_{i = 1}^{n} {A}_{i}^{2}} \sqrt{{\sum }_{i = 1}^{n} {B}_{i}^{2}}}$$

In one embodiment, log analysis module 208 determines if the cosine distance is less than a threshold value, which may be user-designated, in order to determine if an error in the corpus of errors and actions handling such errors in database 305 closely matches an error recorded in log message 303. Such a determination is shown by element 307. The results of such a determination are shown in element 308.

If the cosine distance is less than a threshold value, then log analysis module 208 stores an error type, an error reason, an error time, and an error position in a matrix 309. The analysis then continues evaluating the cosine distance between a different pairing of vectors from each set of vectors 304, 306.

If, however, the cosine distance is not less than a threshold value, then nothing is written in matrix 309 and the analysis continues for evaluating the cosine distance between a different pairing of vectors from each set of vectors 304, 306.

Log analysis module 208 continues such an analysis to generate matrix 309 (identified as A herein) until there are no further pairs of vectors from each set of vectors 304, 306 to be evaluated with respect to their cosine distance.

Upon completing such an analysis, matrix 309 is outputted 310, where output 310 consists of identifier 302 of the associated node 201 (e.g., node 201A) and matrix 309 associated with node 201 (e.g., node 201A) that is identified by identifier 302.

In one embodiment, such log information 301 is converted into a matrix, such as matrix 309, consisting of n rows and four columns, forming matrix Aₙₓ₄

In one embodiment, if the type of error is a warning, then the value of such a type of error is −1; whereas, if the type of error is a non-warning, then the value of such a type of error is 1.

Returning to FIG. 2, in one embodiment, computer 101 further includes the software plug-in referred to herein as the “status value calculation module” 209A-209H for each node 201A-201H, respectively. Status value calculation modules 209A-209H may collectively or individually be referred to as status value calculation modules 209 or status value calculation module 209, respectively.

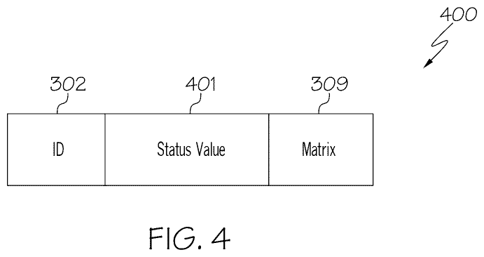

In one embodiment, status value calculation module 209 is configured to generate a data structure for each node 201 in the multisystem of computer 101 that includes an identifier (e.g., identifier 302 of FIG. 3) of the node (e.g., node 201), a status value representing a health status of the node (e.g., node 201), and the matrix (e.g., matrix 309 of FIG. 3) as discussed below in connection with FIG. 4.

FIG. 4 illustrates a data structure 400 that is generated for each node 201 by status value calculation module 209 in accordance with an embodiment of the present disclosure.

Referring to FIG. 4, in conjunction with FIG. 3, data structure 400 generated for each node 201 by status value calculation module 209 includes various fields, including fields for storing identifier 302 of node 201, a status value 401 representing a health status of node 201, and matrix 309.

In one embodiment, status value calculation module 209 calculates a value for status value 401 based on the number of errors and warnings for the associated node 201.

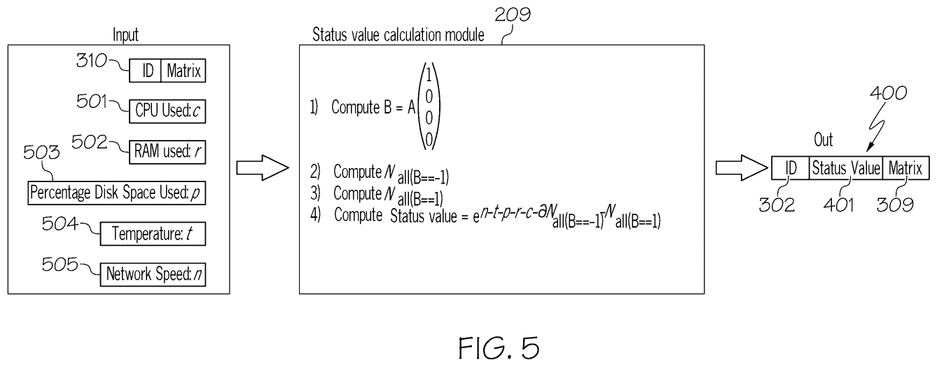

In one embodiment, status value calculation module 209 calculates a value for status value 401 based on an amount of processing used by node 201, an amount of memory used by node 201, a percentage of disk space used by node 201, a temperature of node 201, and a network speed as discussed below in connection with FIG. 5.

FIG. 5 illustrates calculating a value for status value 401 by status value calculation module 209 in accordance with an embodiment of the present disclosure.

Referring to FIG. 5, in conjunction with FIGS. 3-4, in one embodiment, status value calculation module 209 calculates the value of status value 401 based on output 310 of log analysis module 208 (consists of identifier 302 of node 201 and matrix 309), an amount of processing used by node 201, designated by c (see element 501), an amount of memory used by node 201, designated by r (see element 502), a percentage of disk space used by node 201, designated by p (see element 503), a temperature of node 201, designated by t (see element 504), and a network speed, designated by n (see element 505).

In one embodiment, status value calculation module 209 calculates the value of status value 401 (B) based on processing the first column elements of matrix A, such as

$$B = A \cdot ( \begin{matrix}1 \\ 0 \\ 0 \\ 0\end{matrix} ) ,$$

where the first column elements of matrix A consist of the number of errors and warnings. Furthermore, in one embodiment, status value calculation module 209 calculates N_{all(B==-1)}, which represents the number of −1 (represent warnings) in the first column elements of the B matrix, and calculates N_{all(B==1)}, which represents the number of 1 (represents errors) in the first column elements of the B matrix. In one embodiment, the value of status value 401 equals e^{n-t-p-r-c-δN}^{_{all(B==−1)}}^{-N}^{_{all(B==1)}}. Based on the value of status value 401, the heath status of node 201 may be determined, where the higher the value of status value 401, the better the performance of node 201.

In one embodiment, status value calculation module 209 outputs data structure 400, which includes fields for storing identifier 302 of node 201, status value 401 representing a health status of node 201, and matrix 309.

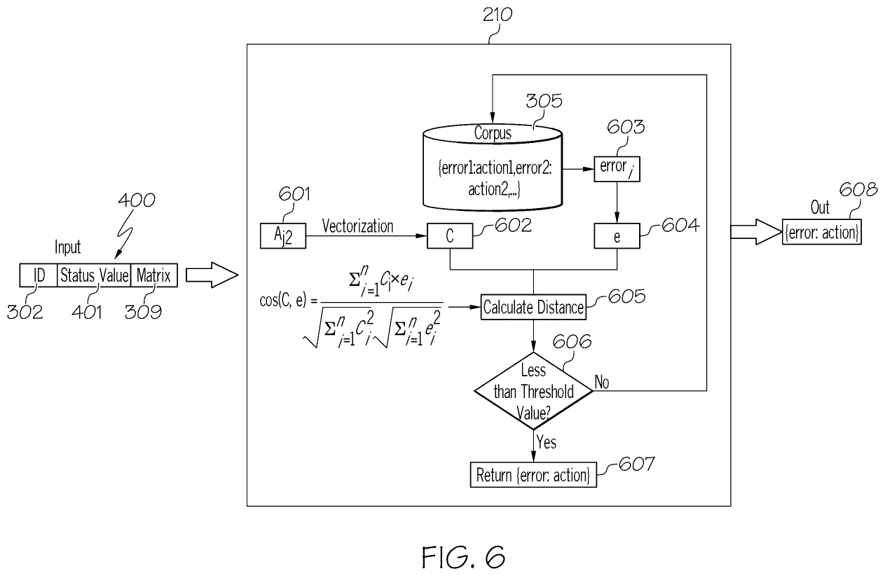

Returning to FIG. 2, computer 101 additionally includes error response and processing module 210 configured to quantify the error information in the second column of matrix 309 and return a corresponding action to handle such an identified error as illustrated in FIG. 6.

FIG. 6 illustrates quantifying the error information in the second column of matrix 309 (matrix of log information) and returning a corresponding action to handle such an identified error by error response and processing module 210 in accordance with an embodiment of the present disclosure.

Referring to FIG. 6, in conjunction with FIGS. 3-4, error response and processing module 210 receives data structure 400 associated with a particular node 201, which consists of identifier 302 of node 201, status value 401 representing a health status of node 201, and matrix 309. In one embodiment, error response and processing module 210 receives such a data structure 400 for each node 201 in the multisystem of computer 101. In one embodiment, error response and processing module 210 performs the following processing steps for each node 201 in the multisystem of computer 101.

In one embodiment, error response and processing module 210 quantifies the error information in the second column of matrix 309 (Aⱼ₂) (see element 601) by vectorizing the second column of matrix 309 (Aⱼ₂) (see element 601) forming a set of vectors 602 (identified by C). Furthermore, in one embodiment, error response and processing module 210 vectorizes a corpus of errors 603 (errorᵢ) stored in database 305 (contains a corpus of errors and actions for handling such errors) forming a set of vectors 604 (identified by e).

In one embodiment, error response and processing module 210 computes (see element 605) a distance between a vector from the set of vectors 602 and a vector from the set of vectors 604, such as computing the cosine distance. In one embodiment, error response and processing module 210 computes the cosine distance between C and e using the following formula:

$$cos ( c , e ) = \frac{{\sum }_{i = 1}^{n} {c}_{i} \times {e}_{i}}{\sqrt{{\sum }_{i = 1}^{n} {c}_{i}^{2}} \sqrt{{\sum }_{i = 1}^{n} {e}_{i}^{2}}}$$

In one embodiment, error response and processing module 210 determines (see element 606) if the distance between the vector from the set of vectors 602 and the vector from the set of vectors 604 is less than threshold value, which may be user-designated.

If the distance between the vector from the set of vectors 602 and the vector from the set of vectors 604 is less than the threshold value, then error response and processing module 210 selects the error and the corresponding action for handling the error (see element 607) stored in the corpus associated with the vector from the set of vectors 604 (resides within database 305).

Error response and processing module 210 then determines if there are other pairs of vectors from the sets of vectors 602, 604 to be evaluated with respect to their cosine distance. If there is another pair of vectors from the sets of vectors 602, 604 to be evaluated with respect to their cosine distance, then error response and processing module 210 repeats the above-described process in computing the distance between such a pair of vectors. Otherwise, the process has been completed in quantifying the error information for an error in matrix 309.

If, however, the distance between the vector from the set of vectors 602 and the vector from the set of vectors 604 is not less than the threshold value, then error response and processing module 210 determines if there are other pairs of vectors from the sets of vectors 602, 604 to be evaluated with respect to their cosine distance as discussed above.

Upon selecting an error and a corresponding action for handling the error (see element 607), error response and processing module 210 outputs (see element 608) the selected error and corresponding action for handling the error.

In one embodiment, error response and processing module 210 implements the action for handling the error for the particular node 201 (e.g., node 201A) in question.

Upon implementing the action for handling the error for the particular node 201 (e.g., node 201A) in question, error response and processing module 210 updates the value of status value 401 in data structure 400 for node 201 (e.g., node 201A).

A particular node 201, such as node 201 (e.g., node 201A) whose error was handled, may then be selected to be added to the schedule for participating in the automation test, such as discussed below in connection with decision-making module 211.

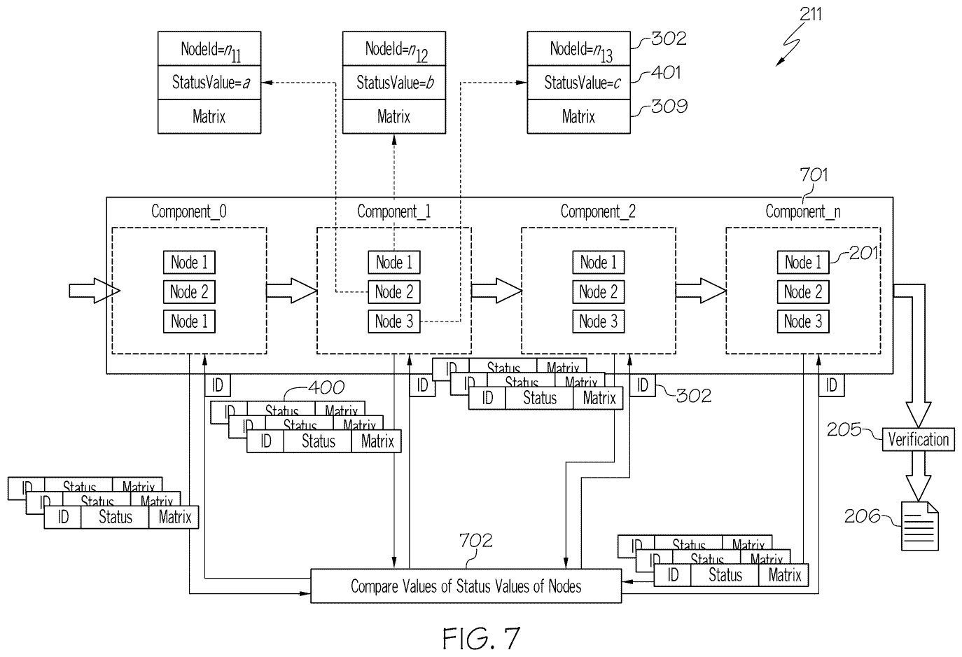

Returning to FIG. 2, computer 101 additionally includes decision-making module 211 configured to select node 201 to be added to the schedule for participating in the automation test as discussed below in connection with FIG. 7.

FIG. 7 illustrates selecting node 201 to be added to the schedule for participating in the automation test by decision-making module 211 in accordance with an embodiment of the present disclosure.

Referring to FIG. 7, in conjunction with FIG. 2, in one embodiment, decision-making module 211 pre-runs the automation test on nodes 201 for all components 701 (component_0 . . . component_n, where n is a positive integer number) (e.g., processing units, etc.) of computer 101 in order to calculate a value for status value 401 for each node 201. As previously discussed, the value of status value 401 corresponds to the health status of node 201.

In one embodiment, decision-making module 211 selects node 201 with the highest value for status value 401 of data structure 400, where an error has been processed by error response and processing module 210, by comparing the values of the status values 401 (see element 702) in data structures 400 for such nodes 201.

In one embodiment, decision-making module 211 returns identifier 302, which identifies the selected node 201, to error response and processing module 210, so that error response and processing module 210 is able to add the selected node 201 to the scheduling system for participating in the automation test.

In one embodiment, error response and processing module 210 schedules the selected node 201 for participating in the automation test.

In one embodiment, error response and processing module 210 is configured to perform the automation test of the multisystem of computer 101, including performing the automation test that includes the scheduled node 201.

In one embodiment, error response and processing module 210 updates the value of status value 401 in data structure 400 for the scheduled node 201 upon performing the automation test on node 201.

In one embodiment, error response and processing module 210 determines if the updated value of status value 401 in data structure 400 is not less than a threshold value, which may be user-designated, and if an error occurred. If the updated value of status value 401 in data structure 400 is not less than a threshold value and an error occurred, then error response and processing module 210 selects an action for handling the error stored in the corpus of errors and actions for handling such errors (corpus resides in database 305 of FIG. 3) in the manner discussed above.

Otherwise, error response and processing module 210 runs such a node 201 as a running node. That is, such a node 201 functionally operates as normal in the multisystem of computer 101.

In this manner, automation testing is effectively implemented in a multisystem, including in situations involving the occurrence of an error, since the errors of the nodes of the multisystem are handled prior to performing the automation test.

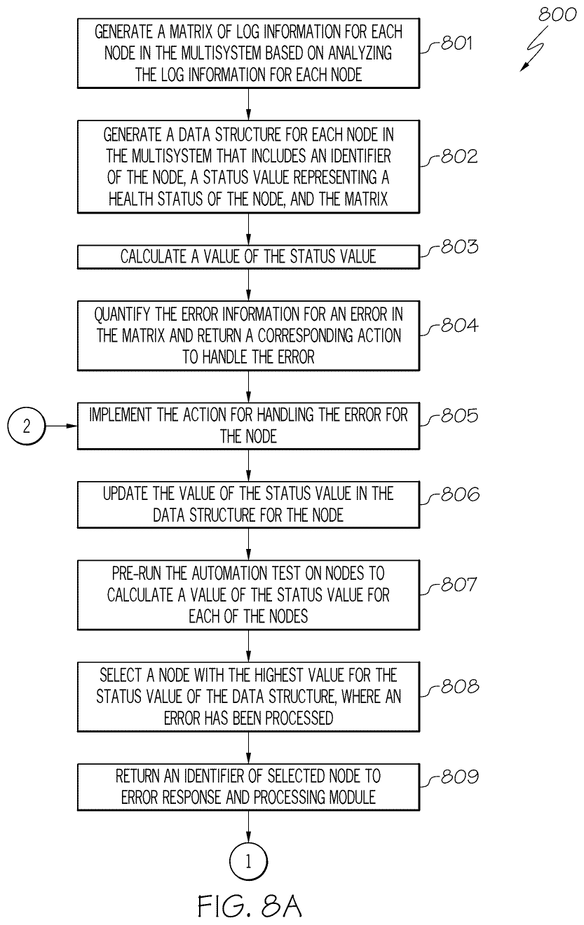

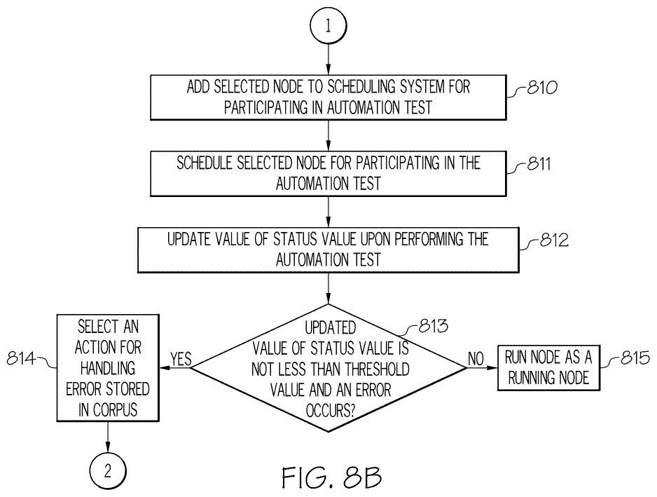

A discussion regarding the method for effectively implementing automation testing in a multisystem, including in situations involving the occurrence of an error, is provided below in connection with FIGS. 8A-8B.

FIGS. 8A-8B are a flowchart of a method 800 for effectively implementing automation testing in a multisystem, including in situations involving the occurrence of an error, in accordance with an embodiment of the present disclosure.

Referring to FIG. 8A, in conjunction with FIGS. 1-7, in step 801, log analysis module 208 generates a matrix of log information for each node 201 in the multisystem based on analyzing the log information for each node 201 as discussed below in connection with FIG. 3.

Referring to FIG. 3, in conjunction with FIG. 2, log analysis module 208 (e.g., log analysis module 208A) is configured to receive log information 301, which includes an identifier 302 (“ID”) of the associated node 201 (e.g., node 201A) and the log message 303.

As discussed above, log message 303, as used herein, is record of an event that occurs in computer 101, such as an error, problem, or information about current operations. In one embodiment, log messages are created as part of the process of logging, which is the act of recording events in computer 101.

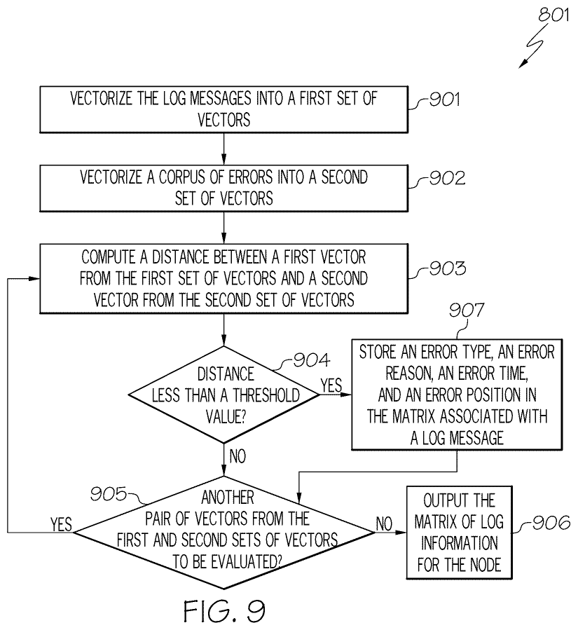

A further discussion regarding log analysis module 208 generating a matrix of log information for each node 201 in the multisystem based on analyzing the log information for each node 201 is provided below in connection with FIG. 9.

FIG. 9 illustrates the sub-steps involved in step 801 in generating a matrix of log information for each node 201 in the multisystem based on analyzing the log information for each node 201 in accordance with an embodiment of the present disclosure.

Referring to FIG. 9, conjunction with FIGS. 1-7 and 8A, in step 901, log analysis module 208 vectorizes each log for node 201 into a vector 304. That is, log analysis module 208 vectorizes log messages 303 for node 201 into a set of vectors 304.

In step 902, log analysis module 208 vectorizes a corpus of errors stored in database 305 (contains a corpus of errors and actions for handling such errors). That is, log analysis module 208 vectorizes the corpus of errors into a set of vectors 306.

As stated above, in one embodiment, such a database 305 is connected to computer 101 (FIG. 1), including via a network 124. In one embodiment, the corpus of errors and actions of database 305 is populated by an expert.

In step 903, log analysis module 208 computes the distance between a vector from each set of vectors 304, 306, such as computing the cosine distance. For example, log analysis module 208 computes a distance between a first vector from the set of vectors 304 and a second vector from the set of vectors 306. In one embodiment, the cosine distance between the vectors A, B is defined as:

$$cos ( A , B ) = \frac{{\sum }_{i = 1}^{n} {A}_{i} \times {B}_{i}}{\sqrt{{\sum }_{i = 1}^{n} {A}_{i}^{2}} \sqrt{{\sum }_{i = 1}^{n} {B}_{i}^{2}}}$$

In step 904, log analysis module 208 determines if the cosine distance is less than a threshold value, which may be user-designated, in order to determine if an error in the corpus of errors stored in database 305 closely matches the error recorded in log message 303.

If the cosine distance is not less than a threshold value, then, in step 905, log analysis module 208 determines if there is another pair of vectors from each set of vectors 304, 306 to be evaluated with respect to their cosine distance.

If there is another pair of vectors from each set of vectors 304, 306 to be evaluated, then log analysis module 208 computes the cosine distance between such a pair of vectors from each set of vectors 304, 306 in step 903.

If, however, there are no further pairs of vectors from each set of vectors 304, 306 to be evaluated, then, in step 906, log analysis module 208 outputs matrix 309 of log information for node 201.

Referring to step 904, if, however, the cosine distance is less than a threshold value, then, in step 907, log analysis module 208 stores an error type, an error reason, an error time, and an error position in a matrix 309.

Upon storing the error type, the error reason, the error time, and the error position in matrix 309, log analysis module 208 determines if there is another pair of vectors from each set of vectors 304, 306 to be evaluated with respect to their cosine distance in step 905.

As discussed above, upon completing the analysis discussed above in connection with FIG. 9, matrix 309 is outputted 310, where output 310 consists of identifier 302 of the associated node 201 (e.g., node 201A) and matrix 309 associated with node 201 (e.g., node 201A) that is identified by identifier 302.

In one embodiment, such log information 301 is converted into a matrix, such as matrix 309, consisting of n rows and four columns, forming matrix Aₙₓ₄

In one embodiment, if the type of error is a warning, then the value of such a type of error is −1; whereas, if the type of error is a non-warning, then the value of such a type of error is 1.

Returning to FIG. 8A, in conjunction with FIGS. 1-7, in step 802, status value calculation module 209 generates a data structure for each node 201 in the multisystem of computer 101 that includes an identifier (e.g., identifier 302) of the node (e.g., node 201), a status value representing a health status of the node (e.g., node 201), and the matrix (e.g., matrix 309 of FIG. 3) as discussed below in connection with FIG. 4.

Referring to FIG. 4, in conjunction with FIG. 3, data structure 400 generated for each node 201 by status value calculation module 209 includes various fields, including fields for storing identifier 302 of node 201, a status value 401 representing a health status of node 201, and matrix 309.

In step 803, status value calculation module 209 calculates a value for status value 401, such as based on the number of errors and warnings for the associated node 201.

In one embodiment, status value calculation module 209 calculates a value for status value 401 based on an amount of processing used by node 201, an amount of memory used by node 201, a percentage of disk space used by node 201, a temperature of node 201, and a network speed as discussed below in connection with FIG. 5.

Referring to FIG. 5, in conjunction with FIGS. 3-4, in one embodiment, status value calculation module 209 calculates the value of status value 401 based on output 310 of log analysis module 208 (consists of identifier 302 of node 201 and matrix 309), an amount of processing used by node 201, designated by c (see element 501), an amount of memory used by node 201, designated by r (see element 502), a percentage of disk space used by node 201, designated by p (see element 503), a temperature of node 201, designated by t (see element 504), and a network speed, designated by n (see element 505).

In one embodiment, status value calculation module 209 calculates the value of status value 401 (B) based on processing the first column elements of matrix A, such as

$$B = A \cdot ( \begin{matrix}1 \\ 0 \\ 0 \\ 0\end{matrix} ) ,$$

where the first column elements of matrix A consist of the number of errors and warnings. Furthermore, in one embodiment, status value calculation module 209 calculates N_{all(B==-1)}, which represents the number of −1 (represent warnings) in the first column elements of the B matrix, and calculates N_{all(B==1)}, which represents the number of 1 (represents errors) in the first column elements of the B matrix. In one embodiment, the value of status value 401 equals e^{n-t-p-r-c-δN}^{_{all(B==−1)}}^{-N}^{_{all(B==1)}}. Based on the value of status value 401, the heath status of node 201 may be determined, where the higher the value of status value 401, the better the performance of node 201.

In one embodiment, status value calculation module 209 outputs data structure 400, which includes fields for storing identifier 302 of node 201, status value 401 representing a health status of node 201, and matrix 309.

In step 804, error response and processing module 210 quantifies the error information for an error in the second column of matrix 309 and returns a corresponding action to handle such an identified error as illustrated in FIG. 6.

Referring to FIG. 6, in conjunction with FIGS. 3-4, error response and processing module 210 receives data structure 400 associated with a particular node 201, which consists of identifier 302 of node 201, status value 401 representing a health status of node 201, and matrix 309. In one embodiment, error response and processing module 210 receives such a data structure 400 for each node 201 in the multisystem of computer 101.

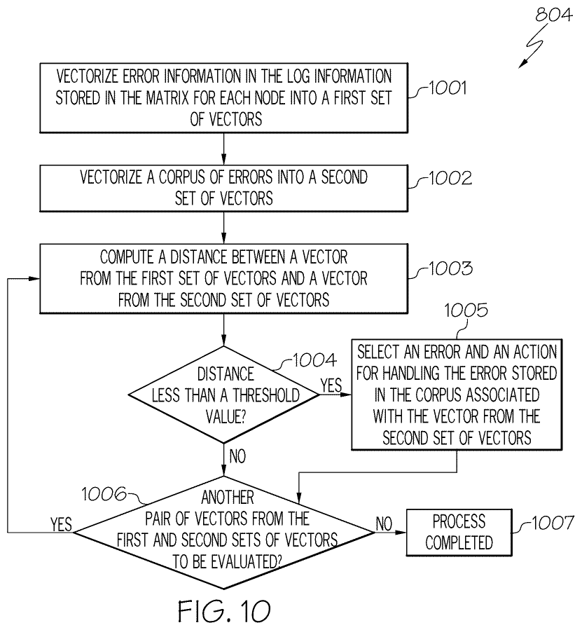

A further discussion regarding error response and processing module 210 quantifying the error information for an error in the second column of matrix 309 and returning a corresponding action to handle such an identified error is provided below in connection with FIG. 10.

FIG. 10 illustrates the sub-steps involved in step 804 in quantifying the error information for an error in the second column of matrix 309 (matrix of log information) and returning a corresponding action to handle such an identified error in accordance with an embodiment of the present disclosure.

Referring to FIG. 10, in conjunction with FIGS. 1-7 and 8A, in step 1001, error response and processing module 210 vectorizes the error information in the log information stored in matrix 309 for each node 201 into a first set of vectors. That is, error response and processing module 210 vectorizes the second column of matrix 309 (Aⱼ₂) (see element 601) forming a first set of vectors 602 (identified by C).

In step 1002, error response and processing module 210 vectorizes a corpus of errors 603 (errorᵢ) stored in database 305 (contains a corpus of errors and actions for handling such errors) forming a second set of vectors 604 (identified by e).

In step 1003, error response and processing module 210 computes (see element 605) a distance between a vector from the first set of vectors 602 and a vector from the second set of vectors 604, such as computing the cosine distance.

As stated above, in one embodiment, error response and processing module 210 computes the cosine distance between C and e using the following formula:

$$cos ( c , e ) = \frac{{\sum }_{i = 1}^{n} {c}_{i} \times {e}_{i}}{\sqrt{{\sum }_{i = 1}^{n} {c}_{i}^{2}} \sqrt{{\sum }_{i = 1}^{n} {e}_{i}^{2}}}$$

In step 1004, error response and processing module 210 determines (see element 606) if the distance between a vector from the first set of vectors 602 and a vector from the second set of vectors 604 is less than threshold value, which may be user-designated.

If the distance between the vector from the first set of vectors 602 and the vector from the second set of vectors 604 is less than the threshold value, then, in step 1005, error response and processing module 210 selects the error and the corresponding action for handling the error (see element 607) stored in the corpus associated with the vector from the second set of vectors 604 (resides within database 305).

In step 1006, error response and processing module 210 determines if there are other pairs of vectors from the sets of vectors 602, 604 to be evaluated with respect to their cosine distance.

If there is another pair of vectors from the sets of vectors 602, 604 to be evaluated with respect to their cosine distance, then error response and processing module 210 computes the distance between the different pair of vectors from the sets of vectors 602, 604 in step 1003.

If, however, there is not another pair of vectors from the sets of vectors 602, 604 to be evaluated with respect to their cosine distance, then, in step 1007, error response and processing module 210 has completed the process in quantifying the error information for an error in matrix 309.

Referring to step 1004, if, however, the computed distance between a vector from the first set of vectors with a vector from the second set of vectors is not less than the threshold value, then error response and processing module 210 determines if there are other pairs of vectors from the sets of vectors 602, 604 to be evaluated with respect to their cosine distance in step 1006.

As discussed above, upon selecting an error and a corresponding action for handling the error (see element 607), error response and processing module 210 outputs (see element 608) the selected error and corresponding action for handling the error.

Returning to FIG. 8A, in conjunction with FIGS. 1-7, in step 805, in one embodiment, error response and processing module 210 implements the action for handling the error for the particular node 201 (e.g., node 201A) in question.

Upon implementing the action for handling the error for the particular node 201 (e.g., node 201A) in question, in step 806, error response and processing module 210 updates the value of status value 401 in data structure 400 for node 201 (e.g., node 201A).

As discussed above, a particular node 201, such as node 201 (e.g., node 201A) whose error was handled, may then be selected to be added to the schedule for participating in the automation test, such as discussed below in connection with decision-making module 211.

In step 807, decision-making module 211 pre-runs the automation test on nodes 201 for all components 701 (component_0 . . . component_n, where n is a positive integer number) (e.g., processing units, etc.) of computer 101 in order to calculate a value for status value 401 for each node 201 as illustrated in FIG. 7.

As previously discussed, the value of status value 401 corresponds to the health status of node 201.

In step 808, decision-making module 211 selects node 201 with the highest value for status value 401 of data structure 400, where an error has been processed by error response and processing module 210, as illustrated in element 702 of FIG. 7.

In step 809, decision-making module 211 returns identifier 302, which identifies the selected node 201, to error response and processing module 210.

Referring now to FIG. 8B, in conjunction with FIGS. 1-7, in step 810, error response and processing module 210 adds the selected node 201 to the scheduling system for participating in the automation test.

In step 811, error response and processing module 210 schedules the selected node 201 for participating in the automation test.

As discussed above, in one embodiment, error response and processing module 210 is configured to perform the automation test of the multisystem of computer 101, including performing the automation test that includes the scheduled node 201.

In step 812, error response and processing module 210 updates the value of status value 401 in data structure 400 for the scheduled node 201 upon performing the automation test on node 201.

In step 813, error response and processing module 210 determines if the updated value of status value 401 in data structure 400 for the scheduled node 201 is not less than a threshold value, which may be user-designated, and if an error occurred.

If the updated value of status value 401 in data structure 400 for the scheduled node 201 is not less than a threshold value and an error occurred, then, in step 814, error response and processing module 210 selects an action for handling the error stored in the corpus (corpus of errors and actions for handling such errors, which is stored in database 305) in the manner discussed above. The selected action for handling the error for the particular node (e.g., scheduled node 201) is then implemented by error response and processing module 210 in step 805.

Otherwise, in step 815, error response and processing module 210 runs such a node 201 as a running node. That is, such a node 201 functionally operates as normal in the multisystem of computer 101.

In this manner, automation testing is effectively implemented in a multisystem, including in situations involving the occurrence of an error, since the errors of the nodes of the multisystem are handled prior to performing the automation test.

Furthermore, the principles of the present disclosure improve the technology or technical field involving multisystems.

As discussed above, multisystems are divided into multiple subsystems. These subsystems collaborate with each other to fulfill computation tasks, showcasing distinctive features, such as large physical distribution (scenario where a large amount of data or computing power is spread across a wide network of geographically dispersed physical servers), large concurrent access (when multiple users or processes can access a system or component at the same time), timing sensitivity, and platform heterogeneity (differences in the underlying hardware, instruction set, and other platform characteristics of a computing system). Furthermore, operational methodologies vary across the different subsystems. For example, communication between subsystems may involve transmitting messages through different network protocols or different local interfaces. Multisystems may be tested using automated testing (also known as “automation testing”). Automated testing is the application of software tools to automate a human-driven manual process of reviewing and validating a software product. Such automated testing may involve the testing of tasks of various components of a customer data platform of the multisystem. A customer data platform is a software application that unifies a company's customer data from multiple sources to create a single, comprehensive database. For example, in order to complete the testing of tasks of the various components of the customer data platform, it is necessary to compare whether the sent data and the received data are consistent. When the received data and the sent data are consistent (i.e., passed verification), then it is concluded that there were no errors. However, when the received data and the sent data are not consistent, then it is said that verification was not passed (i.e., an error occurred). In such a scenario, the software system of the multisystem needs to be debugged to identify the source of the error. However, since the multisystem involves multiple subsystems, which may include different operating systems, the automation test may not succeed in diagnosing the error. For example, it is difficult for the automation test to determine which subsystem or component caused the error. In another example, errors that occurred during the automation test may be complex. For instance, multiple errors may occur during the automation test, and such errors differ in many ways, such as network fluctuations, node downtime, etc. Furthermore, diagnosing errors that occur during the automation test may involve analyzing the log files. However, the log files of the components and nodes (e.g., processing nodes) of the multisystem are complex thereby making it difficult to quickly find useful information to be analyzed. As a result, there is not currently a means for effectively implementing automation testing in a multisystem.

Embodiments of the present disclosure improve such technology by generating a matrix of information for each node in the multisystem based on analyzing the log information for each node. In one embodiment, the matrix includes error information, such as an error type, an error reason, an error time, and an error position. Error information for an error in the matrix for a node in the multisystem is then quantified and a corresponding action to handle the error is then returned. The action for handling the error for the node is then implemented followed by scheduling the node for participating in the automation test. In this manner, automation testing may be effectively implemented in a multisystem, including in situations involving the occurrence of an error. Furthermore, in this manner, there is an improvement in the technical field involving multisystems.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for implementing an automation test in a multisystem, the method comprising:
generating a matrix of log information for each node in said multisystem based on analyzing said log information for each node;
quantifying error information for an error in said matrix for a first node in said multisystem and returning a corresponding action to handle said error;
implementing said action for handling said error for said first node; and
scheduling said first node for participating in said automation test.

2. The method as recited in claim 1 further comprising:
vectoring said log information stored in said matrix for said first node in said multisystem into a first set of vectors, wherein said log information stored in said matrix comprises an error type;
vectorizing a corpus of errors into a second set of vectors;
computing a distance between a first vector from said first set of vectors with a second vector from said second set of vectors; and
selecting said error and said action for handling said error stored in said corpus in response to said distance between said first vector from said first set of vectors and said second vector from said second set of vectors being less than a first threshold value.

3. The method as recited in claim 1 further comprising:
generating a data structure for each node in said multisystem that comprises an identifier of said node, a status value representing a health status of said node, and said matrix;
pre-running said automation test on nodes of said multisystem to calculate a value of said status value of said data structure for each of said nodes;
selecting a node with a highest value of said status value of said data structure that has processed an error; and
adding said selected node to a scheduling system for participating in said automation test.

4. The method as recited in claim 3, wherein a value of said status value is calculated based on an amount of processing used by said node, an amount of memory used by said node, a percentage of disk space used by said node, a temperature of said node, and a network speed.

5. The method as recited in claim 1 further comprising:
vectorizing log messages for said first node into a first set of vectors;
vectorizing a corpus of errors into a second set of vectors;
computing a distance between a first vector from said first set of vectors and a second vector from said second set of vectors; and
storing an error type, an error reasons, an error time, and an error position in said matrix associated with a log message in response to said distance between said first vector from said first set of vectors and said second vector from said second set of vectors being less than a second threshold value.

6. The method as recited in claim 1 further comprising:
generating a data structure for each node in said multisystem that comprises an identifier of said node, a status value representing a health status of said node, and said matrix; and
updating a value of said status value of said data structure of said first node upon performing said automation test on said first node.

7. The method as recited in claim 6 further comprising:
selecting a second action for handling a second error stored in a corpus of errors and actions handing said errors in response to said updated value of said status value not being less than a threshold value and said second error occurs.

8. The method as recited in claim 6 further comprising:
running said first node as a running node in response to said updated value of said status value being less than a threshold value.

9. A computer program product for implementing an automation test in a multisystem, the computer program product comprising one or more computer readable storage mediums having program code embodied therewith, the program code comprising programming instructions for:
generating a matrix of log information for each node in said multisystem based on analyzing said log information for each node;
generating a data structure for each node in said multisystem that comprises an identifier of said node, a status value representing a health status of said node, and said matrix;
quantifying error information for an error in said matrix for a first node in said multisystem and returning a corresponding action to handle said error;
implementing said action for handling said error for said first node; and
scheduling said first node for participating in said automation test.

10. The computer program product as recited in claim 9, wherein the program code further comprises the programming instructions for:
vectoring said log information stored in said matrix for said first node in said multisystem into a first set of vectors, wherein said log information stored in said matrix comprises an error type;
vectorizing a corpus of errors into a second set of vectors;
computing a distance between a first vector from said first set of vectors and a second vector from said second set of vectors; and
selecting said error and said action for handling said error stored in said corpus in response to said distance between said first vector from said first set of vectors with said second vector from said second set of vectors being less than a first threshold value.

11. The computer program product as recited in claim 9, wherein the program code further comprises the programming instructions for:
generating a data structure for each node in said multisystem that comprises an identifier of said node, a status value representing a health status of said node, and said matrix;
pre-running said automation test on nodes of said multisystem to calculate a value of said status value of said data structure for each of said nodes;
selecting a node with a highest value of said status value of said data structure that has processed an error; and
adding said selected node to a scheduling system for participating in said automation test.

12. The computer program product as recited in claim 11, wherein a value of said status value is calculated based on an amount of processing used by said node, an amount of memory used by said node, a percentage of disk space used by said node, a temperature of said node, and a network speed.

13. The computer program product as recited in claim 9, wherein the program code further comprises the programming instructions for:
vectorizing log messages for said first node into a first set of vectors;
vectorizing a corpus of errors into a second set of vectors;
computing a distance between a first vector from said first set of vectors and a second vector from said second set of vectors; and
storing an error type, an error reasons, an error time, and an error position in said matrix associated with a log message in response to said distance between said first vector from said first set of vectors and said second vector from said second set of vectors being less than a second threshold value.

14. The computer program product as recited in claim 9, wherein the program code further comprises the programming instructions for:
generating a data structure for each node in said multisystem that comprises an identifier of said node, a status value representing a health status of said node, and said matrix; and
updating a value of said status value of said data structure of said first node upon performing said automation test on said first node.

15. The computer program product as recited in claim 14, wherein the program code further comprises the programming instructions for:
selecting a second action for handling a second error stored in a corpus of errors and actions handing said errors in response to said updated value of said status value not being less than a threshold value and said second error occurs.

16. The computer program product as recited in claim 14, wherein the program code further comprises the programming instructions for:
running said first node as a running node in response to said updated value of said status value being less than a threshold value.

17. A system, comprising:
a memory for storing a computer program for implementing an automation test in a multisystem; and
a processor connected to said memory, wherein said processor is configured to execute program instructions of the computer program comprising:
generating a matrix of log information for each node in said multisystem based on analyzing said log information for each node;
generating a data structure for each node in said multisystem that comprises an identifier of said node, a status value representing a health status of said node, and said matrix;
quantifying error information for an error in said matrix for a first node in said multisystem and returning a corresponding action to handle said error;
implementing said action for handling said error for said first node; and
scheduling said first node for participating in said automation test.

18. The system as recited in claim 17, wherein the program instructions of the computer program further comprise:
vectoring said log information stored in said matrix for said first node in said multisystem into a first set of vectors, wherein said log information stored in said matrix comprises an error type;
vectorizing a corpus of errors into a second set of vectors;
computing a distance between a first vector from said first set of vectors and a second vector from said second set of vectors; and
selecting said error and said action for handling said error stored in said corpus in response to said distance between said first vector from said first set of vectors with said second vector from said second set of vectors being less than a first threshold value.

19. The system as recited in claim 17, wherein the program instructions of the computer program further comprise:
generating a data structure for each node in said multisystem that comprises an identifier of said node, a status value representing a health status of said node, and said matrix;
pre-running said automation test on nodes of said multisystem to calculate a value of said status value of said data structure for each of said nodes;
selecting a node with a highest value of said status value of said data structure that has processed an error; and
adding said selected node to a scheduling system for participating in said automation test.

20. The system as recited in claim 19, wherein a value of said status value is calculated based on an amount of processing used by said node, an amount of memory used by said node, a percentage of disk space used by said node, a temperature of said node, and a network speed.
